(19) United States
(12) Patent Application Publication
(10) Pub. No.: US 2026/0300950 A1
(43) Pub. Date: Oct. 1, 2026

(54) PRESCRIPTIVE RECOMMENDATIONS FOR SELF-CHECKOUT (SCO) INTERVENTIONS

(71) Applicant: NCR Voyix Corporation, Atlanta, GA (US)

(72) Inventors: Itamar David Laserson, Givat Shmuel (IL); Shay Marom, Kiryat Tiv'on (IL)

(21) Appl. No.: 19/095,391

(22) Filed: Mar. 31, 2025

(51) Int. Cl. G06Q 20/20; G06Q 10/0639

(52) U.S. Cl. CPC G06Q 20/208; G06Q 10/06393

(57) ABSTRACT

Methods and a system for self-checkout (SCO) interventions optimization applies a multi-layer machine learning model (MLM) to identify stores with high intervention overhead, defined as percentage of time wasted on interventions during transactions. Historical SCO transaction data is analyzed to detect underperforming metrics, set achievable improvement targets, and generate specific recommendations. Using a hierarchical structure of MLMs, it first optimizes the SCO excess transaction time key performance indicator (KPI) through two key metrics: intervention-impacted transaction ratio and average intervention duration. Next, specific features are identified to improve, such as response times for particular intervention types, transaction-to-attendant ratios during specific shifts, and performance of individual lanes and attendants. This enables store operations personnel to make data-driven decisions that reduce intervention overhead, improve customer experience, and optimize labor allocation without requiring extensive technical expertise.

### BACKGROUND

Self-checkout (SCO) interventions represent a significant challenge for retailers deploying self-service technologies. When interventions occur too frequently or last too long, they create substantial overhead in transaction time, negatively impacting customer experience and reducing adoption of self-checkout. This intervention overhead can vary dramatically between stores. Store operations managers face considerable difficulty in identifying the root causes of excessive interventions, which may include hardware issues, improper/sub-optimal threshold settings, attendant scheduling problems, or insufficient training. Without effective analytical tools, retailers struggle to pinpoint specific issues across their self-checkout deployments, set achievable improvement targets, and develop actionable plans to reduce intervention overhead.

### BRIEF DESCRIPTION OF THE DRAWINGS

FIG. 1 is a diagram of a system for prescriptive recommendations to improve key performance indicators (KPIs) associated with self-checkout (SCO) interventions, according to an example embodiment.

FIG. 2 is a flow diagram of a method for providing prescriptive recommendations to improve KPIs associated with SCO interventions, according to an example embodiment.

FIG. 3 is a flow diagram of another method for providing prescriptive recommendations to improve KPIs associated with SCO interventions, according to an example embodiment.

### DETAILED DESCRIPTION

Self-checkout (SCO) interventions continue to represent one of the largest pain points in a self-checkout deployment. Interventions are primarily required to prevent shrink and assist shoppers, but when they occur too frequently or last too long, shoppers will not adopt this transaction channel, resulting in increased labor costs and customer dissatisfaction. Intervention overhead (also referred to as excess transaction time) – which may be defined as the ratio of the time associated with a SCO intervention to the total SCO transaction time - can range, for example, anywhere between around 25% in low-performing stores to around 2% in high-performing stores, thus representing a substantial opportunity for improvement.

Reducing intervention overhead presents significant technical challenges. For instance, reducing intervention frequencies requires complex adjustments to thresholds that could negatively impact shrink prevention or identification of hardware issues. Reducing the duration of interventions is even more technically challenging, requiring optimization of attendant scheduling and proper training for resolving dozens of different types of interventions. Store operations personnel currently lack effective tools to reduce intervention overhead.

Current solutions rely on business intelligence experts manually exploring dashboards and reports to track improvement opportunities. This approach is limited by the availability of highly skilled personnel, is extremely labor-intensive, and is error-prone due to a sole reliance on intuition, rather than data-driven analysis. Furthermore, stores that are trending flat or improving on key metrics struggle even more so to identify opportunities for further improvement, assuming that such opportunities even exist.

The technology disclosed herein provides a technical solution to at least the aforementioned technical problems by addressing the computational challenges of analyzing complex self-checkout intervention data across multiple stores to identify specific improvement opportunities. The technical problem involves processing large volumes of heterogeneous transaction and intervention data, identifying meaningful patterns across different scales of measurement, and generating actionable insights without requiring extensive technical expertise from store operations personnel. The technology disclosed herein solves this technical problem. Additionally, the disclosed technology overcomes the technical challenge of correlating intervention types, frequencies, and durations with specific SCO lanes and attendants to enable targeted improvements to be made while maintaining security and preventing shrink.

More specifically, the technology disclosed herein implements a multi-layer machine learning model (MLM) architecture specifically tailored for SCO intervention analysis. In an example embodiment, this architecture employs regression models that are adjusted to accommodate features from different aspects of SCO operations which relate to assisted interventions. In an example embodiment, the architecture includes a layered predictive model that calculates recommendations hierarchically, first optimizing a key performance indicator (KPI) and then using the KPI optimization results for metric level optimization. To address the varying scales between different features (such as intervention-to-transaction ratios versus average intervention time), the disclosed technology compares and assigns different MLMs suitable to the features' distributions. In an example embodiment, the architecture also incorporates an additional sub-layer of actionable features which can help detect not only general issues at the store level but also identify specific SCO lanes and specific attendants impacting performance measures. Furthermore, the technology disclosed herein includes an "intervention type" selection process which identifies dominant intervention types that have significant impact potential based on their frequency of occurrence and variability across stores.

In an embodiment, methods and a system apply a hierarchical logical layer of metrics and features related to the SCO interventions excess transaction time KPI. This KPI is defined as the percentage of time associated with self-checkout interventions in relation to the total self-checkout transaction time. The methods and system organize metrics and features into a structured hierarchy where the KPI is explained by two key metrics: intervention impacted transaction ratio (“InterventionImpactedTrxRatio”) and average intervention duration (“AvgInterventionDuration”).

As used herein, a "KPI" is a high-level metric for which a store measures its success or failure in a certain area or areas of the store's operations. "Metrics" are secondary measurements tied to a given KPI. "Features" are the lowest level measurements.

In an embodiment, the methods and system train on historical data points relating to SCO transactions and interventions to identify stores where the KPI can be significantly improved. The methods and system then set an achievable and measurable improvement target based on the performance of similar stores. For each target, a list of recommendations for specific actions is generated to meet the target.

In an embodiment, the methods and system adjust between the different scales of each model and feature in the hierarchy. This ensures that even if a store doesn't perform better in all measures, it can still receive recommendations for improvement. This is particularly effective for low-performing stores, which are more likely to receive recommendations involving multiple measures. For an intervention type to be considered "dominant enough at the store to make an impact," it must occur with sufficient frequency to significantly affect the overall SCO excess transaction time KPI if improved. For example, if 'INVALID BAG' interventions occur in 15% of all transactions at a particular store and each intervention adds an average of 45 seconds to transaction time, this intervention type would be considered dominant because reducing its frequency could substantially improve the overall KPI. Conversely, if 'RECEIPT PAPER JAM' interventions occur in only 0.5% of transactions, even though each incident might add 120 seconds to transaction time, this intervention type would not be considered dominant enough to prioritize for improvement. The system 100 analyzes both the frequency and duration impact of each intervention type to determine which ones, if improved, would yield the most significant reductions in overall excess transaction time.

In an embodiment, the methods and system adjust between the different scales of each model and feature in the hierarchy. This ensures that even if a particular store doesn't perform better in all measures, the store can still receive recommendations for improvement. This is particularly effective for low-performing stores, which are more likely to receive recommendations involving multiple measures.

In an embodiment, the methods and system provide specific recommendations such as reducing the rate of particular intervention types (e.g., 'INVALID BAG'), reducing average response times for specific intervention types (e.g., 'DEVICE ERROR', 'UNKNOWN ITEM'), and optimizing attendant scheduling during specific time periods (e.g., evening, night shifts). These recommendations are presented in a hierarchical format that starts with an observation about the KPI that can be improved, outlines the underperforming metrics, and provides a list of features that will improve each metric.

In an embodiment, the methods and system can identify specific SCO lanes that experience higher intervention rates and specific attendants who may need additional training or support. This enables targeted improvements rather than general store-wide changes, making the recommendations more efficient and effective.

As previously noted, as used herein, a KPI is a high-level metric for which a store measures its success or failure in a certain area or areas of the store's operations. KPIs are defined based on common industry store operations and practices. For example, KPIs include year-over-year sales performance, weekly/monthly cashier labor hours, self-checkout interventions resulting in excessive transaction times, and others. KPIs are primary measurements of a store's performance. In the context of SCO operations, the primary KPI addressed may be "SCO excess transaction time," which measures the percentage of time spent on SCO interventions out of the total SCO transaction duration.

As previously noted, metrics are secondary measurements tied to a given KPI. The metrics at least partially explain the performance of a KPI. Metrics are typically known to store operations personnel who commonly engage with business intelligence (BI) reporting tools. For the SCO excess transaction time KPI, the key metrics include intervention impacted transaction ratio ("InterventionImpactedTrxRatio" (i.e., the rate of transactions affected by interventions)) and average intervention duration ("AvgInterventionDuration" (i.e., how long interventions typically last)).

As previously noted, features are the lowest level measurements. A feature or a set of features explains a metric or set of metrics. A feature drives a recommendation either directly or implicitly. Features are more specific by their nature; they enable given specific recommendations and are therefore more actionable. For example, features that explain the AvgInterventionDuration metric include average response time, average resolve time for specific intervention types (such as 'DEVICE ERROR' or 'UNKNOWN ITEM'), average transaction-to-attendant ratios for different shifts (e.g., morning, afternoon, evening, night), and various metrics measuring attendant and SCO performance. Features that explain the InterventionImpactedTrxRatio metric include normalized intervention counts for different intervention types, normalized intervention counts per SCO for different intervention types, and maximum items allowed for SCO.

In an embodiment, the methods and system update a user interface visualization in real-time to display improvements in the SCO excess transaction time KPI responsive to implementation of the recommendations. The user interface presents the hierarchical explanation visually, showing the current KPI values, the target improvement values, and the actual improvements achieved as recommendations are implemented. This real-time visualization enables store operations personnel to immediately see the impact of their actions on reducing intervention overhead, further enhancing the ability to make data-driven decisions without requiring extensive technical expertise to interpret the results.

Embodiments herein produce a hierarchical explanation that starts with an observation that the SCO excess transaction time KPI can be improved, lays out metrics that are performing below expectations and that impact the KPI, and for each metric lays out a list of features that will improve the corresponding metric. The identified features are presented as a measurable and achievable target within a user interface and/or provided to an existing business service or an existing business system for automated processing. For example, the methods and system may identify that a store's average interventions excess transaction time can be improved by a specific percentage (e.g., 3.14%), and then provide specific recommendations such as reducing 'INVALID BAG' interventions rate per transaction from 0.06 to 0.05, reducing average response time from 109 seconds to 102 seconds, or reducing average transactions per attendant during evening hours from 16.33 to 13.40. These specific, data-driven recommendations enable store operations personnel to take targeted actions that measurably improve SCO performance without requiring extensive technical expertise to analyze the underlying data.

Embodiments presented herein provide a multi-layer MLM architecture that employs MLMs to analyze SCO intervention data and generate prescriptive recommendations. The hierarchical logical layer organizes data into three distinct levels: KPIs (primary measurements) such as SCO excess transaction time, metrics (secondary measurements) including intervention impacted transaction ratio and average intervention duration, and features (lowest level measurements) such as normalized intervention counts and average response times for specific intervention types. Each layer of MLMs establishes connections between explanatory features and labels - the first layer MLMs predict metric values that affect a given KPI, while the second layer MLMs predict feature values that influence specific metrics. Feature contribution analysis algorithms, such as Shapley Values (SHAP) or local interpretable model-agnostic explanations (LIME), detect the amount of contribution of each feature to changes in the corresponding label, enabling the methods and system to identify which features have the most significant impact on metrics and KPIs. This hierarchical approach allows for efficient computation by filtering out insignificant features based on importance thresholds, focusing optimization efforts on features that meaningfully contribute to improving SCO intervention performance.

The multi-layer MLM architecture and hierarchical approach provide significant technical advantages over conventional manual analysis methods. Unlike traditional approaches that rely on human analysts to manually inspect dashboards and reports—a process that is time-consuming, error-prone, and limited by human cognitive capacity—the MLM architecture can process vast amounts of heterogeneous SCO transaction data simultaneously across multiple stores. The regression MLMs can detect subtle patterns and correlations that would be imperceptible to human analysts, particularly when dealing with features that operate at different scales or have non-linear relationships. By automatically identifying the most significant contributors to poor performance through feature contribution analysis, the method and system eliminate the computational complexity that would make manual analysis prohibitively expensive. Furthermore, the hierarchical structure enables the methods and system to efficiently process data at multiple levels of granularity, from store-wide KPIs down to individual SCO lanes and attendants, providing a level of specificity in recommendations that would be impossible to achieve through manual methods. This represents a fundamental improvement in the technological field of retail operations analysis, transforming what was previously a subjective, experience-based process into a data-driven, computationally efficient system that generates objectively measurable improvements in SCO performance.

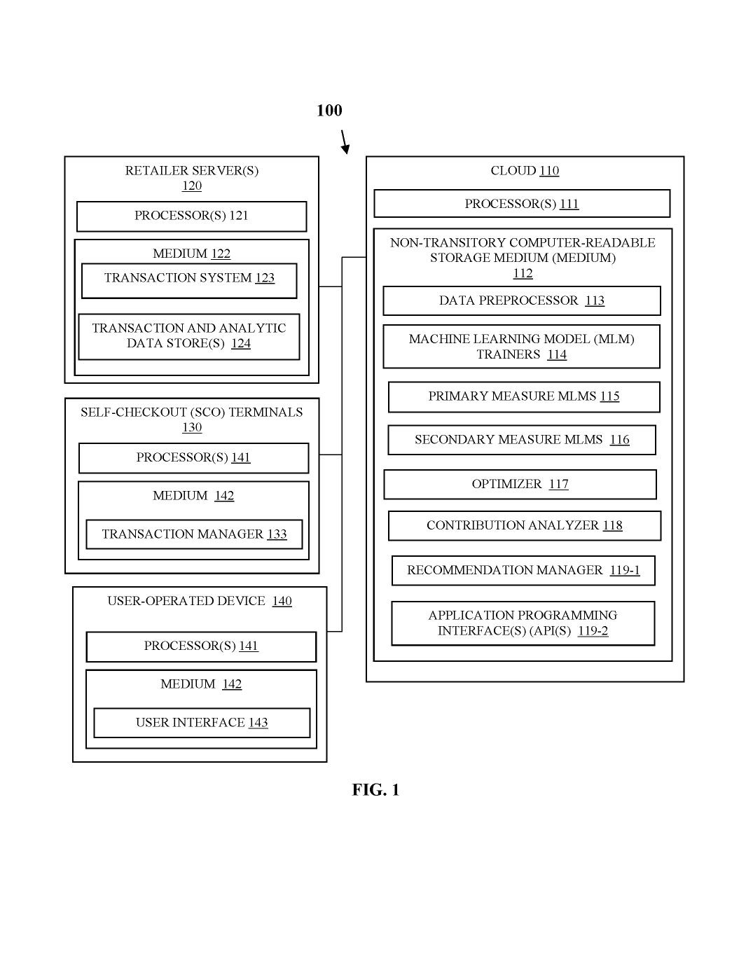

FIG. 1 is a diagram of a system 100 for prescriptive recommendations to improve KPIs associated with SCO interventions, according to an example embodiment. Notably, the components are shown schematically in simplified form, with only those components relevant to understanding of the embodiments being illustrated.

Furthermore, the various components (that are identified in system 100) are illustrated and the arrangement of the components are presented for purposes of illustration only. Notably, other arrangements with more or less components are possible without departing from the teachings of prescriptive recommendations to improve KPIs associated with SCO interventions, presented herein and below.

System 100 includes a cloud 110, one or more retailer servers 120, one or more SCO terminals 130, and one or more user-operated devices 140. Cloud 110 includes at least one processor 111 and a non-transitory computer-readable storage medium (hereinafter “medium”) 112, which includes instructions for data preprocessor 113, MLM trainer(s) 114, primary measure MLMs 115, secondary measure MLMs 116, optimizer 117, contribution analyzer 118, recommendation manager 119-1, and application programming interface(s) (API(s)) 119-2. The instructions when executed by processor 111 cause processor 111 to perform processing or operations discussed herein and below with respect to 113-119-2.

Each retailer server 120 includes at least one processor 121 and a medium 122, which includes instructions for a transaction system 123. The instructions when executed by processor 121 cause processor 121 to perform processing or operations discussed herein and below with respect to 123. Medium 122 also includes transaction and analytic data store(s) 124.

Each SCO terminal 130 includes at least one processor and a medium having instructions for at least a transaction manager 133. The instructions when executed by the processor cause the processor to perform operations associated with the transaction manager 133.

Each user-operated device 140 includes at least one processor 141 and a medium 142, which includes instructions for a user interface (UI) 143. The instructions when executed by processor 141 cause processor 141 to perform processing or operations discussed herein and below with respect to 141.

Data preprocessor 113 is responsible for preparing the input data for the MLMs (115, 116). The data preprocessor 113 obtains raw historical transactional data and analytical data from the transaction and analytic data store(s) 124 of a given retailer server 120. Data preprocessor 113 identifies predefined features from the input data, performs data normalization on the extracted features, and provides missing values for features lacking values. Data preprocessor 113 ensures that the data from transaction and analytic data store(s) 124 is in a suitable format for training and analysis.

MLM trainer(s) 114 trains the primary measure MLMs 115 and the secondary measure MLMs 116. In an embodiment, the MLM trainer(s) 114 use regression MLMs to fit the MLMs to the preprocessed data, establishing connections between explanatory features and labels for both KPIs (primary measures) and metrics (secondary measures).

In an embodiment, the MLM trainer(s) 114 compare many regression MLMs and assign each hierarchy model with the MLM that is suitable to the features distributions. This approach ensures that every store can get a recommendation for improvement, even if a store is better than all other stores in one metric but not in another.

Primary measure MLMs 115 are the first layer of MLMs that predict metric values (e.g., secondary measures) for a given KPI (primary measure). Each primary measure MLM 115 predicts a set of secondary measures (metric values), which correspond to the primary measure (e.g., KPI value). That is, each primary measure MLM 115 is specific to a given primary measure (e.g., KPI). The primary measure MLMs 115 establish the connection between different business metrics (e.g., secondary measures) and corresponding KPIs (e.g., primary measures).

Secondary measure MLMs 116 form the second layer of MLMs that predict feature values for features (i.e., tertiary measures) associated with given metric values (e.g., secondary measures). The secondary MLMs 116 provide more granular insights into the factors affecting each metric or secondary measures underlying corresponding KPIs or primary measures. Each primary measure MLM 115 predicts the most impactful set of metrics that affect a given KPI whereas each secondary MLM predicts the most impactful set of features (e.g., tertiary measures) that affect a given metric.

Optimizer 117 manages the layered predictive MLMs that calculate recommendations hierarchically. Optimizer 117 first optimizes the KPI and then uses the KPI optimization results for metric level optimization, ensuring consistency between the different layers of the multi-layered MLMs. Optimizer 117 also processes an optimization algorithm that considers the possible or potential optimization direction for each feature. This component ensures that features are optimized in the correct direction (increase or decrease) based on their impact on the metrics and KPIs. Additionally, optimizer 117 manages the adjustments between different scales of each MLM and feature in the hierarchy, ensuring the handling of the varying scales and distributions of features within the layered predictive MLMs.

Contribution analyzer 118 employs or processes feature contribution analysis algorithms, such as Shapley Values (SHAP) or local interpretable model-agnostic explanations (LIME), to detect the amount of contribution of every feature (e.g., secondary measure (metric) or tertiary measure (feature)) to the change in label (e.g., KPI value prediction or metric value prediction). Contribution analyzer 118 provides a numerical value representing the relative contribution of each feature. This analysis helps identify which features have the most significant impact on a corresponding KPI or a corresponding metric being optimized.

Recommendation manager 119-1 generates and manages the final recommendations based on the outputs from the various MLMs and optimizers. Recommendation manager 119-1 produces a hierarchical explanation that starts with an observation about a KPI that can be improved, outlines the underperforming metrics that impact the KPI, and provides a list of features that will improve each metric. The recommendation manager 119-1 also handles the differentiation between percentage-based features and absolute values features when calculating possible suggested changes.

API(s) 119-2 provide interfaces for integrating the system's functionality with existing business services or systems, such as transaction system 123 and UI 143. This allows for automated processing and seamless integration of the recommendations into the retailer's existing operational workflows, enabling store managers and operations personnel to access and implement the recommendations through user-operated devices 140.

Transaction system 123 manages the SCO transactions processed by SCO terminals 130. It records transaction data including intervention events, their types, durations, and resolutions. This data is stored in transaction and analytic data store(s) 124, which serves as the primary source of historical data for the system 100 to analyze and generate recommendations.

Transaction manager 133 on SCO terminals 130 handles the customer-facing aspects of SCO operations, processing transactions and triggering interventions when necessary. These interventions might include 'INVALID BAG', 'DEVICE ERROR', 'UNKNOWN ITEM', and other types that require attendant assistance. The transaction manager 133 interacts with transaction system 123 to process transactions and record intervention data.

UI 143 on user-operated devices 140 presents the system's recommendations in an easily understandable format for store managers and other users. The UI 143 receives the recommendations generated by recommendation manager 119-1 through API(s) 119-2, displaying them in a hierarchical format that clearly shows the KPI improvement opportunity, the metrics that need improvement, and the specific features that should be adjusted to achieve the target.

Together, these components form a comprehensive system 100 that enables retailers to identify underperforming SCO intervention KPIs, set achievable targets, and generate specific, data-driven recommendations for improvement. The system 100 leverages advanced machine learning techniques and a hierarchical MLM structure to provide insights that would be difficult or impossible to obtain through manual analysis, thereby significantly enhancing SCO operations management.

Consider the following example scenario illustrating how system 100 operates: a retail store is experiencing high SCO intervention overhead, with excess transaction time at 15% compared to a target of 12%. The data preprocessor 113 obtains historical SCO transaction data from transaction and analytic data store(s) 124, which includes information about intervention types, frequencies, durations, and the specific SCO lanes and attendants involved. The MLM trainer(s) 114 train the primary measure MLMs 115 and secondary measure MLMs 116 on this data.

The primary measure MLMs 115 identify that the store's SCO excess transaction time KPI can be improved by 3.14%. The contribution analyzer 118 determines that both the intervention impacted transaction ratio and average intervention duration metrics significantly contribute to this KPI. The optimizer 117 then calculates that reducing the intervention impacted transaction ratio from 10.15% to 9.55% and reducing the average intervention duration from various percentages (99.03% to 81.87%, 42.57% to 40.36%, etc.) would achieve the target improvement.

The secondary measure MLMs 116 then identify specific features that can be adjusted to improve these metrics. For reducing the intervention impacted transaction ratio, the system 100 recommends reducing 'INVALID BAG' interventions rate per transaction from 0.06 to 0.05, particularly in lane '65'. For reducing average intervention time, the system 100 recommends reducing average response time from 109sec to 102sec, reducing average 'DEVICE ERROR' intervention response time from 177sec to 174sec, reducing average transactions per attendant during evening hours (5pm - 8pm) from 16.33 to 13.40, and other specific adjustments.

The recommendation manager 119-1 compiles these recommendations into a hierarchical explanation that clearly shows the relationship between the KPI, metrics, and features. This information is then made available through API(s) 119-2 to the UI 143 on user-operated devices 140, where store managers can view and implement the recommendations. By following these specific, data-driven recommendations, the store can reduce its SCO intervention overhead, improving customer experience and operational efficiency.

The system 100 acts as a "24/7 supervisor" for SCO operations, continuously analyzing transaction data to identify opportunities for improvement. It provides specific insights about problematic SCO lanes and attendants, enabling targeted interventions rather than general store-wide changes. This approach saves time and labor for retailers while improving the customer experience at SCO, ultimately driving higher adoption rates and operational efficiency.

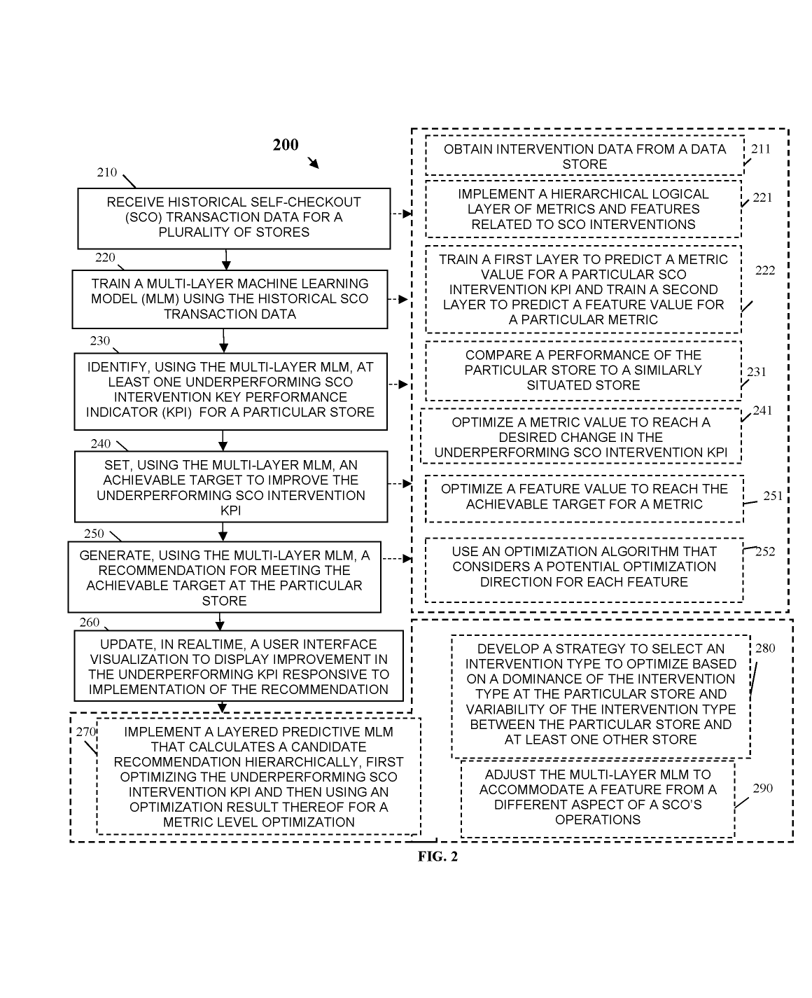

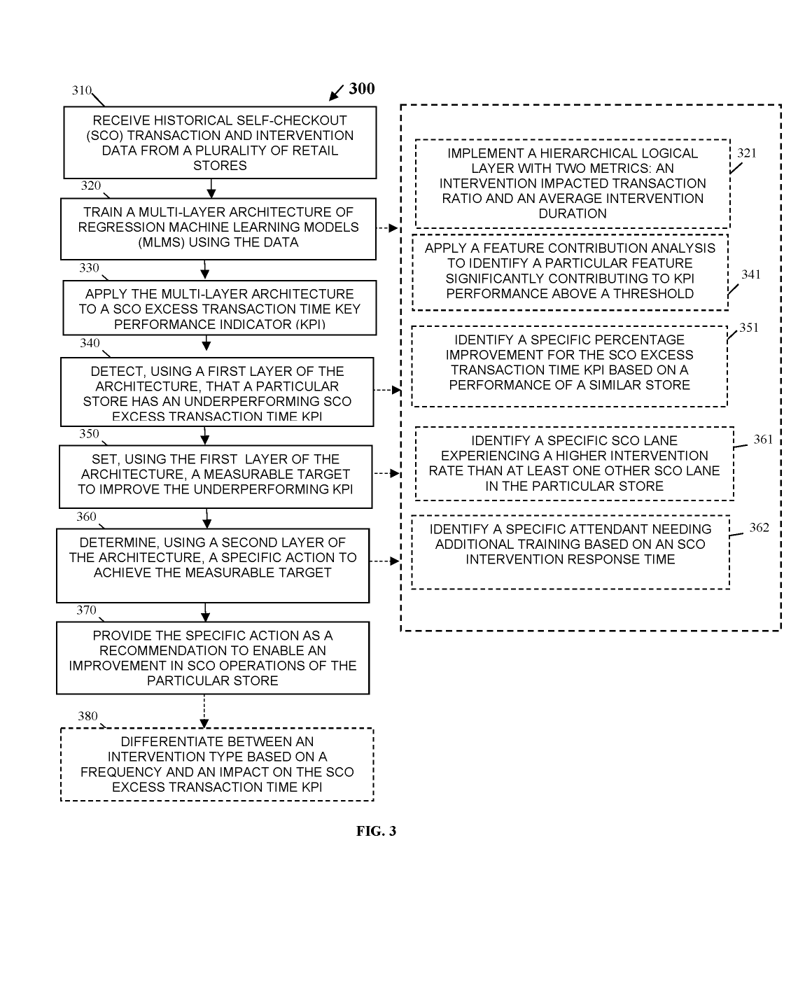

Having described the components and operation of system 100, we now turn to methods for implementing prescriptive recommendations to improve KPIs associated with SCO interventions. FIGS. 2 and 3 illustrate flow diagrams of methods that can be implemented by system 100 to identify underperforming SCO intervention KPIs, set achievable targets, and generate specific recommendations for improvement. These methods leverage the multi-layer MLM architecture and hierarchical approach described above to provide actionable insights for reducing SCO intervention overhead.

The methods illustrated in FIGS. 2 and 3 implement the novel "intervention type" selection process described earlier, which identifies intervention types that have the most significant impact on SCO performance. This selection process considers both the dominance of intervention types at a particular store and the variability of these intervention types across different stores. By focusing on intervention types that meet these criteria, the methods can generate highly targeted recommendations that address the most impactful issues first, maximizing the efficiency of improvement efforts. Additionally, the methods incorporate the ability to identify specific SCO lanes and attendants that contribute disproportionately to intervention overhead, enabling even more granular and effective recommendations.

In an embodiment, the devices that execute the SCO intervention KPI recommender are cloud 110 and/or retailer server 120. In an embodiment, the SCO intervention KPI recommender is data preprocessor 113, MLM trainer(s) 114, primary measure MLMs 115, secondary measure MLMs 116, optimizer 117, contribution analyzer 118, recommendation manager 119-1, and/or API(s) 119-2.

At 210, the SCO intervention KPI recommender receives historical SCO transaction data from a plurality of stores. In an embodiment, at 211, the SCO intervention KPI recommender obtains intervention data from a transaction and analytic data store 124.

At 220, the SCO intervention KPI recommender trains a multi-layer MLM using the historical SCO transaction data. In an embodiment, at 221, the SCO intervention KPI recommender implements a hierarchical logical layer of metrics and features related to SCO interventions. In an embodiment, at 222, the SCO intervention KPI recommender trains a first layer to predict a metric value for a particular SCO intervention KPI and trains a second layer to predict a feature value for a particular metric.

At 230, the SCO intervention KPI recommender identifies, using the multi-layer MLM, at least one underperforming SCO intervention KPI for a particular store. In an embodiment, at 231, the SCO intervention KPI recommender compares a performance of the particular store to a similar store in a retail chain.

At 240, the SCO intervention KPI recommender sets, using the multi-layer MLM, an achievable target to improve the underperforming SCO intervention KPI. In an embodiment, at 241, the SCO intervention KPI recommender optimizes a metric value to reach a desired change in the underperforming SCO intervention KPI.

At 250, the SCO intervention KPI recommender generates, using the multi-layer MLM, a recommendation for meeting the achievable target at the particular store. In an embodiment, at 251, the SCO intervention KPI recommender optimizes a feature value to reach the achievable target for a metric. In an embodiment, at 252, the SCO intervention KPI recommender uses an optimization algorithm that considers a potential optimization direction for each feature.

In an embodiment, at 260, the SCO intervention KPI recommender updated, in real time, a user interface visualization to display improvement in the underperforming SCO intervention KPI responsive to implementation of the recommendation. In an embodiment, at 270, the SCO intervention KPI recommender implements a layered predictive MLM that calculates a candidate recommendation hierarchically, first optimizing the underperforming SCO intervention KPI and then using an optimization result for a metric level optimization. In an embodiment, at 280, the SCO intervention KPI recommender develops a strategy to select an intervention type to optimize based on a dominance of the intervention type at the particular store and variability of the intervention type between the particular store and at least one other store. In an embodiment, at 290, the SCO intervention KPI recommender adjusts the multi-layer MLM to accommodate a feature from a different aspect of SCO operations.

FIG. 3 is a flow diagram of another method 300 for providing prescriptive recommendations to improve KPIs associated with SCO interventions, according to an example embodiment. The software module(s) that implements the method 300 is referred to as an “SCO intervention KPI recommendation manager.” The SCO intervention KPI recommendation manager is implemented as executable instructions programmed and residing within memory and/or a non-transitory computer-readable (processor-readable) storage medium and executed by one or more processors of one or more device(s). The processors that execute the SCO intervention KPI recommendation manager are specifically configured and programmed for processing the SCO intervention KPI recommendation manager. In an embodiment, the SCO intervention KPI recommendation manager may have access to one or more network connections during its processing. The network connections can be wired, wireless, or a combination of wired and wireless.

In an embodiment, the device that executes the SCO intervention KPI recommendation manager is cloud 110 and/or retailer server 120. In an embodiment, the SCO intervention KPI recommendation manager is data preprocessor 113, MLM trainer(s) 114, primary measure MLMs 115, secondary measure MLMs 116, optimizer 117, contribution analyzer 118, recommendation manager 119-1, API(s) 119-2, and/or method 200. The SCO intervention KPI recommendation manager presents another and, in some ways, an enhanced processing perspective from that which was described above for method 200 of FIG. 2.

At 310, the SCO intervention KPI recommendation manager receives historical SCO transaction and intervention data from a plurality of retail stores. At 320, the SCO intervention KPI recommendation manager trains a multi-layer architecture of regression MLMs using the historical SCO transaction and intervention data. In an embodiment, at 321, the SCO intervention KPI recommendation manager implements a hierarchical logical layer with two metrics: an intervention impacted transaction ratio and an average intervention duration.

At 330, the SCO intervention KPI recommendation manager applies the multi-layer architecture to an SCO excess transaction time KPI. At 340, the SCO intervention KPI recommendation manager detects, using a first layer of the multi-layer architecture, that a particular store has an underperforming SCO excess transaction time KPI.

At 350, the SCO intervention KPI recommendation manager sets, using the first layer of the multi-layer architecture, a measurable target to improve the underperforming SCO excess transaction time KPI. In an embodiment, at 351, the SCO intervention KPI recommendation manager identifies a specific percentage improvement for the SCO excess transaction time KPI based on a performance of a similar store.

At 360, the SCO intervention KPI recommendation manager determines, using a second layer of the multi-layer architecture, a specific action to achieve the measurable target. In an embodiment, at 361, the SCO intervention KPI recommendation manager identifies a specific SCO lane or SCO terminal 130 experiencing a higher intervention rate than at least one other SCO lane in the particular store. In an embodiment, at 362, the SCO intervention KPI recommendation manager identifies a specific attendant needing additional training based on an SCO intervention response time associated with the specific attendant.

At 370, the SCO intervention KPI recommendation manager provides the specific action as a recommendation to enable an improvement in SCO operations of the particular store. In an embodiment, at 380, the SCO intervention KPI recommendation manager differentiates between an intervention type based on a frequency and an impact on the SCO excess transaction time KPI.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method comprising:
receiving historical self-checkout (SCO) transaction data for a plurality of stores;
training a multi-layer machine learning model (MLM) using the historical SCO transaction data;
identifying, using the multi-layer MLM, at least one underperforming SCO intervention key performance indicator (KPI) for a particular store;
setting, using the multi-layer MLM, an achievable target to improve the at least one underperforming SCO intervention KPI;
generating, using the multi-layer MLM, a recommendation for meeting the achievable target at the particular store; and
updating, in real time, a user interface visualization to display improvement in the at least one underperforming SCO intervention KPI responsive to implementation of the recommendation.

2. The method of claim 1, wherein receiving the historical SCO transaction data further comprises obtaining intervention data from a data store.

3. The method of claim 1, wherein training the multi-layer MLM further comprises implementing a hierarchical logical layer of metrics and features related to SCO interventions.

4. The method of claim 1, wherein training the multi-layer MLM further comprises training a first layer to predict a metric value for a particular SCO intervention KPI and training a second layer to predict a feature value for a particular metric.

5. The method of claim 1, wherein identifying the at least one underperforming SCO intervention KPI further comprises comparing a performance of the particular store to a similarly situated store.

6. The method of claim 1, wherein setting the achievable target further comprises optimizing a metric value to reach a desired change in the at least one underperforming SCO intervention KPI.

7. The method of claim 1, wherein generating the recommendation further comprises optimizing a feature value to reach the achievable target for a metric.

8. The method of claim 1, wherein generating the recommendation further comprises using an optimization algorithm that considers a potential optimization direction for each feature.

9. The method of claim 1, further comprising adjusting the multi-layer MLM to accommodate a feature from a different aspect of a SCO’s operations.

10. The method of claim 1, further comprising implementing a layered predictive MLM that calculates a candidate recommendation hierarchically, first optimizing the at least one underperforming SCO intervention KPI and then using an optimization result thereof for a metric level optimization.

11. The method of claim 1, further comprising developing a strategy to select an intervention type to optimize based on a dominance of the intervention type at the particular store and variability of the intervention type between the particular store and at least one other store.

12. A method comprising:
receiving historical self-checkout (SCO) transaction and intervention data for a plurality of retail stores;
training a multi-layer architecture of regression machine learning models (MLMs) using the historical SCO transaction and intervention data;
applying the multi-layer architecture to a SCO excess transaction time key performance indicator (KPI);
detecting, using a first layer of the multi-layer architecture, that a particular store has an underperforming SCO excess transaction time KPI;
setting, using the first layer, a measurable target to improve the underperforming SCO excess transaction time KPI;
determining, using a second layer of the multi-layer architecture, a specific action to achieve the measurable target; and
providing the specific action as a recommendation to enable an improvement in SCO operations of the particular store.

13. The method of claim 12, wherein training the multi-layer architecture further comprises implementing a hierarchical logical layer with two metrics: an intervention impacted transaction ratio and an average intervention duration.

14. The method of claim 12, wherein detecting the underperforming SCO excess transaction time KPI further comprises applying a feature contribution analysis to identify a particular feature significantly contributing to KPI performance above a threshold.

15. The method of claim 12, wherein setting the measurable target further comprises identifying a specific percentage improvement for the SCO excess transaction time KPI based on a performance of a similar store.

16. The method of claim 12, wherein determining the specific action further comprises identifying a specific SCO lane experiencing a higher intervention rate than at least one other SCO lane in the particular store.

17. The method of claim 12, wherein determining the specific action further comprises identifying a specific attendant needing additional training based on a SCO intervention response time.

18. The method of claim 12, further comprising differentiating between an intervention type based on a frequency and an impact on the SCO excess transaction time KPI.

19. A system comprising:
a processor;
a memory storing instructions that, when executed by the processor, cause the system to:
implement a multi-layer architecture of machine learning model (MLM) for a self-checkout (SCO) intervention key performance indicator (KPI);
identify, using the multi-layer architecture, at least one underperforming SCO intervention KPI for a store;
set, using the multi-layer architecture, an achievable improvement target for the at least one underperforming SCO intervention KPI;
generate, using the multi-layer architecture, a list of recommendations for meeting the achievable improvement target; and
provide the list of recommendations to enable an improvement in SCO operation for the store.

20. The system of claim 19, wherein the instructions further cause the processor to adjust the multi-layer architecture to accommodate a feature from a different aspect of SCO operation and differentiate between an intervention type based on their dominance at the store and variability between at least one additional store.
